(19) United States
(12) Patent Application Publication
(10) Pub. No.: US 2012/0150746 A1
(43) Pub. Date: Jun. 14, 2012

(54) METHODS AND SYSTEMS FOR DIGITAL COUPON REDEMPTION

(75) Inventor: Bruce Robert Graham, Austin, TX (US)

(73) Assignee: eBay Inc., San Jose, CA (US)

(21) Appl. No.: 12/963,366

(22) Filed: Dec. 8, 2010

(51) Int. Cl. G06Q 30/00; H04L 9/28

(52) U.S. Cl. 705/50; 705/14.23

(57) ABSTRACT

Methods and systems for redeeming digital coupons within a network-based system are disclosed. For example, a method can include receiving a payment request, accessing a digital coupon, validating the digital coupon, applying the validated digital coupon, and processing payment of a revised payment request. The payment request includes sufficient information for a payment processor to transfer funds between a user and a merchant. Receiving the payment request also includes a reference to a digital coupon associated with an item included in the payment request. The digital coupon is accessed using the reference received from the user within the payment request. Validating the digital coupon creates a validated digital coupon that is applied against the payment request to create a revised payment request.

### COPYRIGHT NOTICE

A portion of the disclosure of this patent document contains material that is subject to copyright protection. The copyright owner has no objection to the facsimile reproduction by anyone of the patent document or the patent disclosure, as it appears in the Patent and Trademark Office patent files or records, but otherwise reserves all copyright rights whatsoever. The following notice applies to the software and data as described below and in the drawings that form a part of this document: Copyright 2009, eBay, Inc. All Rights Reserved.

### TECHNICAL FIELD

This application relates generally to transactions over a distributed network and, more specifically, to methods and systems for digital coupon redemption during payment processing associated with an online transaction.

### BACKGROUND

Traditional paper coupons delivered through the mail or in the newspaper have been used by organizations for years to incent desired customer behaviors. The basic delivery mechanisms for traditional coupons have changed little over the years even as new technologies have altered the way the typical consumer receives purchase information, makes purchase decisions, and conducts transactions.

The advent of the Internet has driven the development of new methods of delivering information to consumers and provided marketers additional avenues for delivering promotional information, such as electronic mail. The ease and relatively low cost of sending out electronic promotional information has led to a dramatic increase in the amount of promotional information received by the average consumer. Interestingly, most promotional information remains completely anonymous, untargeted, and generally ignored by the recipient. Some efforts at personalization and targeted marketing have been developed through mechanisms such as opt-in electronic mail programs.

As part of the electronic marketing revolution driven primarily by the ease of communication over the Internet, coupon delivery has also moved online. However, other than the mechanism of delivery, coupons have changed little in the transition to electronic delivery (e.g., digital coupons). Digital coupons typically are anonymous promotions that offer a small discount off retail pricing targeted at large groups of consumers. Even coupons delivered through some sort of opt-in electronic marketing campaign will be redeemable by anyone that receives the offer.

### BRIEF DESCRIPTION OF THE DRAWINGS

Some embodiments are illustrated by way of example and not limitation in the figures of the accompanying drawings in which:

FIG. 1 is a block diagram illustrating an example system for digital coupon redemption.

FIG. 2 is a block diagram illustrating an example system for digital coupon redemption including example communication flow between entities, according to an example embodiment.

FIG. 3 is a flowchart illustrating an example method for digital coupon redemption.

FIG. 4 is a swim-lane diagram illustrating an example method for digital coupon redemption.

FIG. 5 is a block diagram illustrating an example architecture for a network-based publication system within which methods and systems for dynamically issuing coupons can be implemented.

FIG. 6 is a block diagram illustrating an example system for dynamically issuing coupons.

FIG. 7 is a block diagram illustrating an example coupon system, which can be implemented as part of a network-based publication system.

FIG. 8 is a high-level entity-relationship diagram, illustrating various tables that may be maintained within databases supporting the network-based publication system, and that are utilized by and support the network-based publication system applications.

FIG. 9 is a block diagram illustrating example fields in an example coupon table.

FIG. 10 is a diagrammatic representation of machine in the example form of a computer system within which a set of instructions for causing the machine to perform any one or more of the methodologies discussed herein, may be executed.

### DETAILED DESCRIPTION

Example methods and systems to redeem digital coupons are discussed. The systems and methods for redeeming digital coupons, in some example embodiments, may involve a payment processing system (or service) handling application of a digital coupon to a transaction prior to processing the requested transfer of funds associated with the transaction. In the following description, for purposes of explanation, numerous specific details are set forth in order to provide a thorough understanding of example embodiments. It will be evident, however, to one skilled in the art that the present subject matter may be practiced without these specific details. It will also be evident that digital coupon redemption is not limited to the examples provided and may include other scenarios not specifically discussed.

In accordance with an example embodiment, a coupon creation system can issue a digital coupon to a user who fits one or more specified criteria while the user is browsing a network-based publication system (also referred to as the “site”), such as for example a network-based marketplace, a network-based store, or other commerce enabling system. In this example, a digital coupon refers to a coupon issued to a user for later use against the purchase of goods or services from one or more merchants (sellers). In some examples, digital coupons may include real-time coupons that are issued during a session browsing a network-based publication system. Digital coupons are also referred to generally as simply “coupons” throughout much of the following description.

In the context of coupon generation and delivery, both real-time and instantaneous refer to the generation and/or delivery occurring immediately. However, in the context of any computerized system, “immediately,” “real-time,” or “instantaneous” are all constrained by the time it takes for the process under computer control to occur. In an example, the criteria controlling coupon generation (or delivery to a particular user) can include a previous purchase by the user, the user's gender, or a combination of similar parameters. In some examples, the criteria can be the performance of certain actions by the user on the site, which can be monitored in real-time. For example, on an auction-based site, losing a certain number of auctions could trigger a coupon to be issued. In additional examples, triggering actions can include buying an item associated with an up-selling campaign, winning a “competitive” auction (e.g., an auction with multiple bids from the same bidder(s)), or buying an item associated with featured accessories. In some examples, the user's actions are monitored in real-time on the site. In certain examples, the user's actions are derived from analyzing historical transaction data. The historical transaction data can be analyzed in regular batches (e.g., daily or weekly). In an example, the user's actions can be determined from a combination of monitored activity and historical transaction data analysis. In some additional examples, criteria for issuing a coupon to the user can also include user profile data, which can include demographics tracked by the network system.

Various methods can be used to select users as eligible to receive a digital coupon. For example, coupon issuance models can be developed based on historical transaction data from a network-based publication system. These historical coupon issuance models can then be applied to a user's activity while browsing the site. The coupon issuance model can include rules or conditions that the user must satisfy, such as the user purchased an item in a specified category or the purchase price for the purchased item is at least a specified dollar amount. The following is a list of example rules that can be included in a coupon issuance model:
The user purchased an item using a coupon (or not using a coupon).
The previous M item(s) that the user purchased were not paid with a coupon in the last D1 days.
The user has made less than T purchases in the last D2 days.
The user has redeemed less than K coupons within the same campaign in the last D3 days.
The user has outstanding payments (or not). An outstanding payment is defined as:
   Any incomplete or pending payment of won items in the past 2 weeks.
   The number of successful bids is not equal to the number of completed payments in the last 2 weeks.
The user has live bids (or not). This is defined as:
   The user is the highest bidder on any live auction.
   The end date of this live auction is prior to the expiration date of the dynamic issuance coupon that will be issued.
The user is a rewards or loyalty program participant (or not).
   Additionally, lists of eligible users can be created based on demographics or the individual user's purchase history. User demographics can include age, gender, income level, race, education, hobbies, or any personal characteristic that may be collected or recorded about an individual user. In certain examples, an administrative interface is provided to allow creation of eligible user lists.

Once the coupon creation system determines that a coupon is going to be issued to a user, the coupon can be presented within the network-based publication system through various avenues. For example, the coupon could be delivered to the user through some sort of on-site messaging system, such as while the user is viewing an item relevant to the coupon. A coupon can also be surfaced within the user's account page. The network-based publication system's web interface is configurable to provide visual indications of a coupon, such as through a page header common across multiple pages of the site. In certain examples, the coupon may be issued and surfaced during the check out process. In an example, the digital coupon generated by a coupon creation system can be encrypted and stored within the coupon creation system. In this example, the coupon delivered to a user can be a reference to the digital coupon stored within the coupon creation system. A coupon reference can include all the information a user may need to redeem the coupon, such as discount, applicable products or services, and participating merchants (sellers).

In one example embodiment, the user is issued a coupon targeted specifically at the user. Targeted variable value coupons can be used for user-specific, targeted incentives related to rewards programs and courtesy coupon programs. The coupon creation system can create coupons with different discount amounts, percentage discounts, and expiration dates for individual users. In this embodiment, the targeted coupon can only be redeemed by the user to whom it was issued. In certain examples, each individual user can be assigned a unique coupon redemption code (or reference). In some examples, the targeted coupons are redeemed based on the user's login credentials with the network-based publication system. In other examples, the targeted coupons are redeemed based on the user's email address. In yet other examples, the targeted coupons are redeemed through the user's method of payment, such as via Paypal™ online payment services (from eBay Inc. of San Jose, Calif.) or a credit card.

In some examples, a coupon campaign can be controlled through a coupon budgeting engine within a coupon creation system. The coupon budgeting engine allows a merchandiser, marketing person, or individual merchant to control the approximate dollar amount of coupons issued through the system. The coupon budgeting engine also allows for control over the coupon campaign's start and end dates, as well as coupon expiration dates. The coupon budgeting engine can be implemented as a stand-alone web application used to submit coupon metadata to a coupon infrastructure hosted by the network-based publication system or an external coupon creation system. As individual unique coupons are issued to each eligible user, the coupon budgeting engine can provide the capability to suspend or cancel individual coupons or an entire campaign.

Further details regarding the various example embodiments described above will now be discussed with reference to the figures accompanying the present specification.

### Digital Coupon Redemption

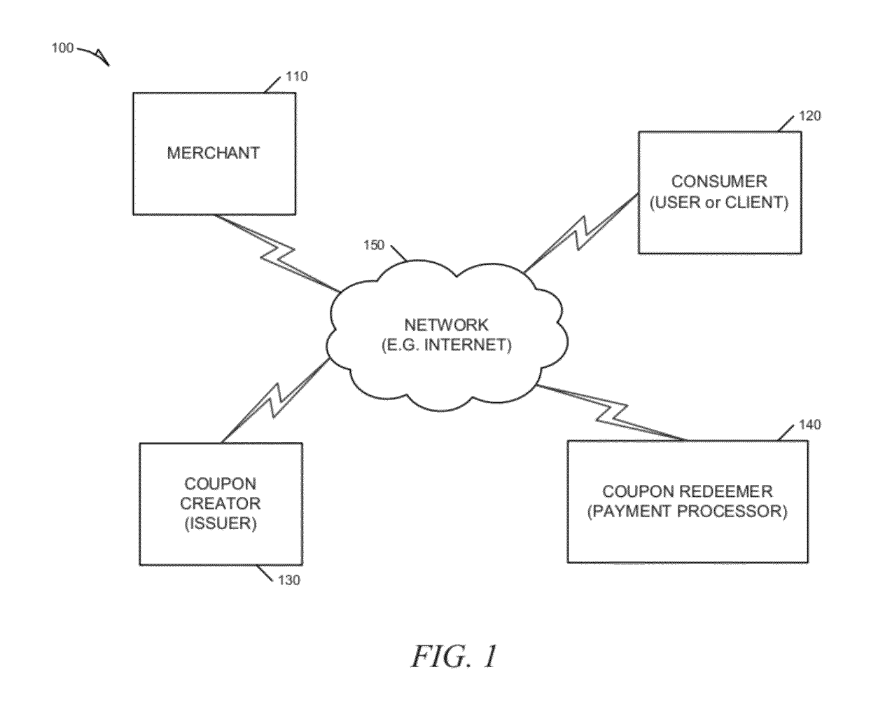

FIG. 1 is a block diagram illustrating an example system 100 for digital coupon redemption. The system 100 includes a merchant 110, a consumer (client) 120, a coupon creator 130, and a coupon redeemer 140. The system 100 connects the merchant 110, consumer 120, coupon creator 130, and coupon redeemer 140 over a network 150. The network 150 can represent any suitable communication network topology. In an example, the network 150 is a quasi-public wide area network, such as the Internet.

In an example, the merchant 110 can be any individual or organization offering products or services for sale over a network, such as the Internet. In some examples, the merchant 110 can be an entity listing items within a network-based publication system. In certain examples, the merchant 110 can be an entity operating an ecommerce site, such as overstock.com (from Overstock.com of Salt Lake City, Utah) or buy.com (from Buy.com, Inc. of Aliso Viejo, Calif.).

In an example, the consumer 120 can be any individual or organization capable of purchasing goods or services over the network 150. In an example, the consumer 120 can represent a user connecting to the network 150 with a personal computer, mobile handheld device, or similar device capable of communicating over the network 150. While the system 100 depicts a single consumer 120 and merchant 110, the system 100 is not limited to use by a single consumer or single merchant.

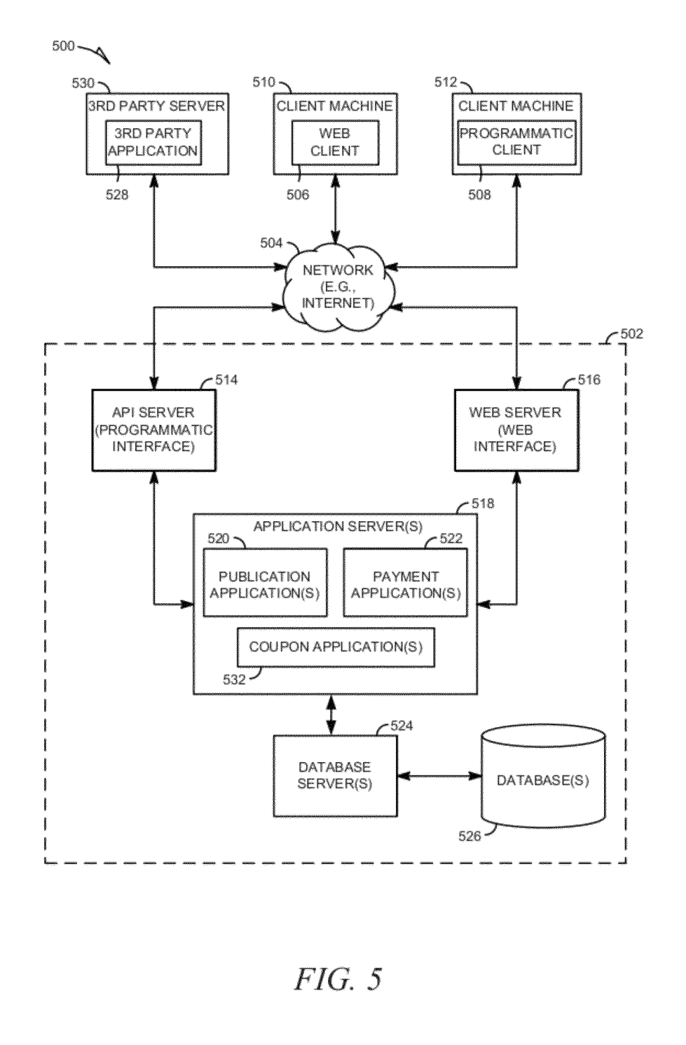

The coupon creator 130 can be any individual or organization capable of creating digital coupons and distributing references to the coupons (e.g., coupon identifiers) to the consumer 120. In an example, the coupon creator 130 can be part of a network-based publication system, online marketplace, or ecommerce site. In another example, the coupon creator 130 can be a stand-alone system connected to the network 150 for the purpose of creating, delivering, and managing digital coupons. In yet another example, the coupon creator 130 can be integrated with the coupon redeemer 140 as a single system. In any of the examples discussed above, the coupon creator 130 may be implemented on a dedicated server with an internal or external database for digital coupon storage. FIGS. 5 through 9 include a detailed description of an example coupon creation system.

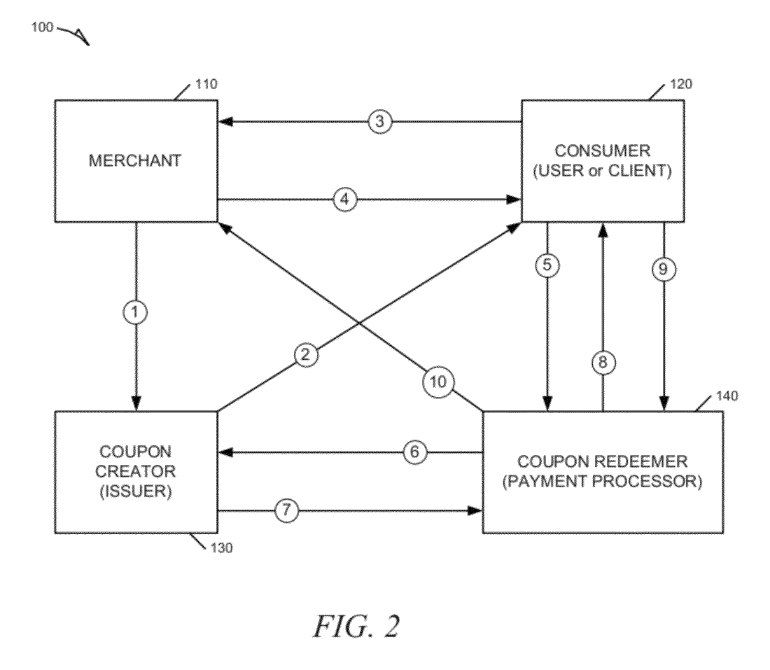

FIG. 2 is a block diagram illustrating the example system 100 for digital coupon redemption including example communication flows between entities, according to an example embodiment. As discussed above in reference to FIG. 1, the system 100 can include the merchant 110, the consumer 120, the coupon creator 130, and the coupon redeemer 140 connected over network 150 (not shown in FIG. 2). FIG. 2 includes a series of numbered arrows between the entities indicating example communication flows during coupon creation, delivery, and redemption.

In an example, the communication flows begin at 1 with the merchant 110 sending a request to the coupon creator 130 to instantiate a coupon (or configure a coupon campaign). The merchant 110 can specify valid start and end dates, the benefit amount (e.g., fixed discount, percentage off, etc.), application items (Stocking Units (SKUs)), and target consumers (or target consumer requirements), among other things. The coupon creator 130 can use the coupon information provided by the merchant 110 to create a coupon (or launch a coupon campaign to create multiple coupons according to the parameters provided).

In an example, at communication 2, the coupon creator 130 sends a unique coupon reference (e.g., a coupon identifier) to the consumer 120 via email or some other form of electronic communication supported by the network 150. In certain examples, the coupon creator 130 can also send a physical mailer to the consumer 120 that includes the unique coupon reference and other information sufficient to allow the consumer 120 to utilize the coupon. In an example, the coupon reference provided by the coupon creator 130 includes information such as discount amount, issuing merchant, applicable SKUs (or other item identifier), applicable item categories, and expiration date.

In an example, at communication 3 the consumer 120 selects an item offered by merchant 110 and referenced by the digital coupon. After selecting an item, the consumer 120 initiates a purchase process with the merchant. In some examples, the purchase process can involve additional entities, such as a network-based marketplace that may also be hosting the coupon creator 130. In this example, the merchant 110, at communication 4, sends the consumer 120 an invoice for purchase of the selected item.

In an example, at communication 5, the consumer 120 sends the invoice received from the merchant 110 and the coupon reference (received from the coupon creator 130) to the coupon redeemer 140. At communication 6, the coupon redeemer 140 sends the coupon reference to the coupon creator 130 to request the digital coupon. At communication 7, the coupon creator 130 sends the coupon redeemer 140 a copy of the digital coupon. In some examples, the digital coupon sent by the coupon creator 130 is encrypted to protect against fraud. In these examples, the coupon creator 130 also provides the coupon redeemer 140 with a shared public key, allowing the coupon redeemer 140 to decrypt the digital coupon.

After receiving the digital coupon from the coupon creator 130, the coupon redeemer 140 can validate the coupon and apply it against the invoice. In an example, at communication 8, the coupon redeemer 140 sends a revised invoice back to the consumer 120 for approval. The revised invoice includes the value of the coupon applied against the transaction. If the coupon cannot be validated by the coupon redeemer 140 (wrong item, expired coupon, etc.), the coupon redeemer 140 sends an error message to the consumer within communication 8.

In an example, at communication 9, the consumer 120 sends back an approval message allowing the coupon redeemer 140 to process payment associated with the invoice. In this example, the coupon redeemer 140 is also a payment processor, such as PayPal™ or a credit card gateway, and can perform the necessary functions to transfer funds between the consumer 120 and the merchant 110 to complete the transaction.

In an example, at communication 10, the coupon redeemer 140 can send notification to the merchant 110 regarding the coupon redemption. In certain examples, not shown, the coupon redeemer 140 can also notify the coupon creator 130 that the digital coupon was redeemed by the consumer 120.

FIG. 2 illustrates how the system 100 can utilize the coupon creator 130 and the coupon redeemer 140 to act on behalf of the merchant 110 and consumer 120, respectfully, to ensure that digital coupons are accurately redeemed. The process described can prevent the merchant 110 from arbitrarily cancelling or negating digital coupons, and can also prevent the consumer 120 from defrauding the merchant 110 with a counterfeit, expired, or incorrectly applied coupon.

In an example, an encrypted digital coupon can be safely transmitted from the coupon creator 130 to the coupon redeemer 140 through the use of shared public key encryption. The shared public key allows the coupon redeemer 140 to decode the digital coupon. In this example, neither the merchant 110 nor the consumer 120 need PKI (public key infrastructure) abilities or the potentially significant computational resources required to perform cryptographic operations on the digital coupons.

In an example, the digital coupon created within the process described above, in reference to FIG. 2, can be self-contained, self-descriptive, and secure against modification once created. The merchant 110 can specify that a particular coupon is intended for a specific consumer 120 (targeted coupons). The coupon redeemer 140 can include the necessary infrastructure to verify that only the specified consumer 120 is able to redeem the digital coupon. In an example, the coupon redeemer 140 is also a payment processor, and verification can include using information associated with a payment method, such as a PayPal™ ID or a credit card number. Fraud by either the merchant 110 or the consumer 120 may be avoided, as neither party is provided access to the encrypted digital coupon.

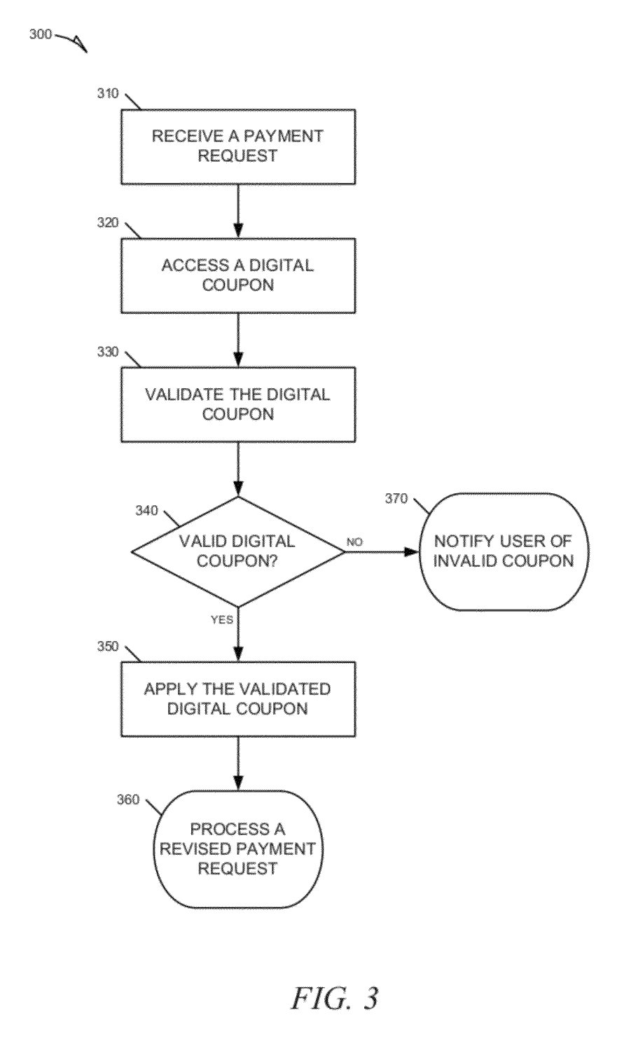

FIG. 3 is a flowchart illustrating an example method 300 for digital coupon redemption. In an example, the method 300 can include operations to receive a payment request (310), access a digital coupon (320), validate the digital coupon (330), determine whether the digital coupon is valid (340), apply the validated digital coupon (350), process a revised payment request (360), and notify a user of an invalid coupon (370).

In an example, the method 300 can begin at 310 with the coupon redeemer 140 receiving a payment request. In this example, the payment request can include a reference to a digital coupon. In certain examples, the coupon redeemer 140 is also a payment processor able to transfer funds based on the payment request. At 320, the method 300 can continue with the coupon redeemer 140 accessing a digital coupon based on the reference provided with the payment request. In an example, the coupon redeemer 140 can access a coupon database directly to obtain the digital coupon. In some examples, the coupon redeemer 140 can communicate with the coupon creator 130 to access the digital coupon.

At 330, the method 300 can continue with the coupon redeemer 140 validating the digital coupon. The coupon redeemer 140 validates that the payment request, and in some examples the associated invoice, satisfies the parameters of the digital coupon. For example, a digital coupon can include rules regarding valid dates for use, valid product or service types, valid categories of items to be discounted, and required total invoice amount, among others.

In an example, the digital coupon can be encrypted to prevent tampering or fraud. In this example, the coupon redeemer 140 can decrypt the digital coupon using information provided by the coupon creator 130 in order to perform the validation. In some examples, the information provided by the coupon creator 130 for decryption purposes can be a public key. In other examples, the decryption information provided to the coupon redeemer 140 can include the keys or secrets necessary to decrypt the digital coupon, and decryption parameters may be dependent upon the type of encryption used during coupon creation.

At 340, the method 300 can continue with the coupon redeemer 140 determining whether the digital coupon is valid for use against the payment request. If the digital coupon is not valid for use against the payment request, the method 300 continues at 370 with the coupon redeemer 140 notifying the user (e.g., consumer 120) who submitted the payment request of the invalid coupon. However, if the digital coupon is valid, the method 300 can continue at 350 with the coupon redeemer 140 applying the validated digital coupon to the payment request. At 360, the method 300 can conclude with the coupon redeemer 140 processing payment against a payment request revised to reflect the application of the digital coupon.

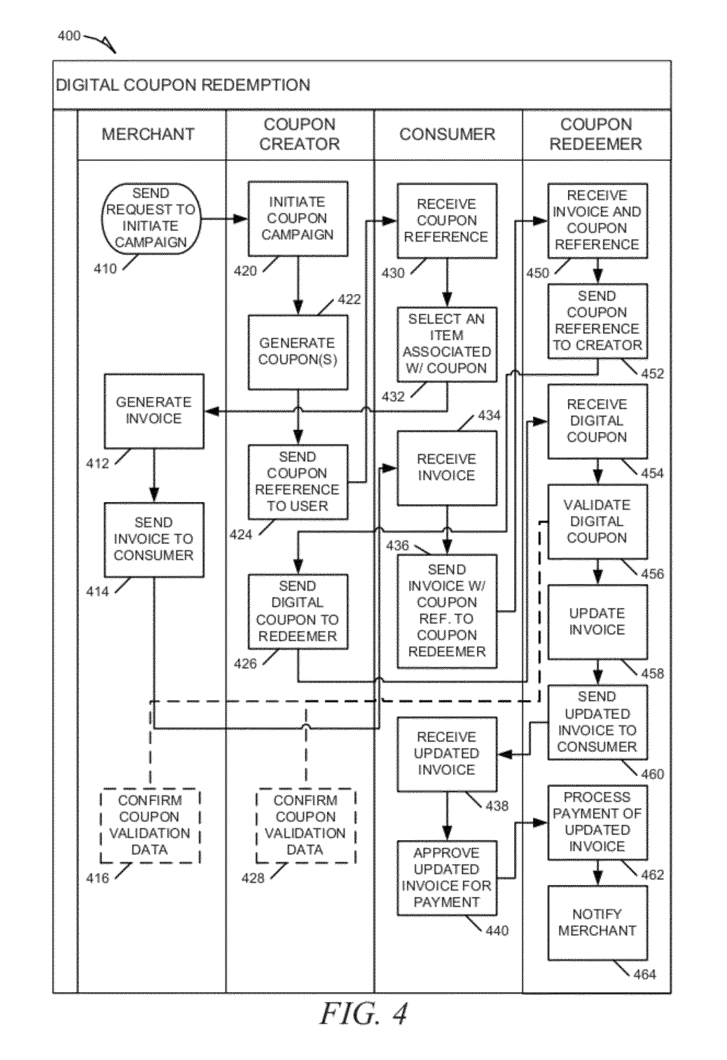

A more detailed method is illustrated in FIG. 4 that includes operations such as approval of the revised payment request and notification back to the merchant of digital coupon use.

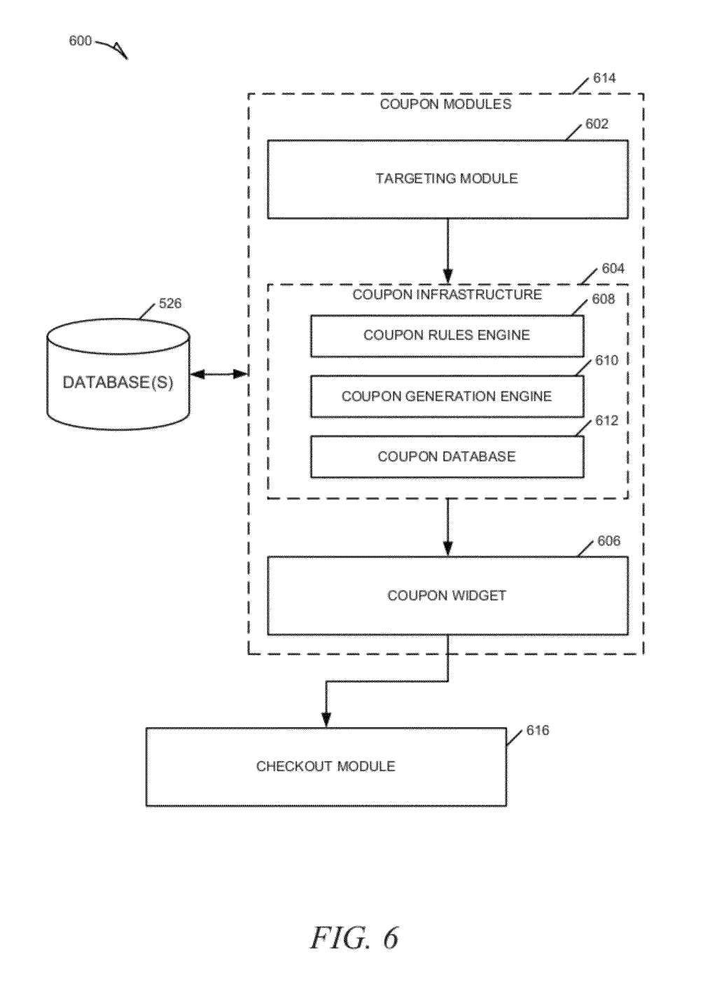

FIG. 4 is a swim-lane diagram illustrating an example method 400 for digital coupon redemption. In an example, the method 400 includes operations performed by the merchant 110, the coupon creator 130, the consumer 120, and the coupon redeemer 140. The method 400 can begin at 410 with the merchant 110 initiating a coupon campaign (or creation of a single coupon) by sending a request to the coupon creator 130. At 420, the method 400 can continue with the coupon creator 130 initiating the coupon campaign requested by the merchant 110. At 422, the method 400 continues with the coupon creator 130 generating a coupon as indicated by the coupon campaign request received from the merchant 110. A coupon campaign can include between one and thousands of coupons (or more). In an example, each coupon that is generated can be targeted for delivery to a specific individual consumer. Targeted coupon delivery is discussed further below in reference to FIGS. 6 through 9.

At 424, the method 400 can continue with the coupon creator 130 sending a coupon reference to the consumer 120. In an example, a coupon reference (or reference to a digital coupon) can include all information necessary for the consumer 120 to successfully redeem the digital coupon, such as merchant, valid dates for use, and applicable items, among others. In an example, the coupon reference includes an identifier that identifies the actual digital coupon that is retained within a coupon database for future reference and validation. Separating the actual coupon from the information sent to the consumer 120 (e.g., the coupon reference) assists in preventing fraud and can provide better control over the coupon redemption process.

At 430, the method 400 continues with the consumer 120 receiving the coupon reference. At 432, the consumer 120 selects an item offered by the merchant 110 that is associated with the digital coupon. At 412, the method 400 continues with the merchant 110 generating an invoice that includes the selected item associated with the digital coupon. In certain examples, the invoice can be generated within a virtual shopping cart or similar electronic commerce system. At 414, the method 400 continues with the merchant 110 sending the invoice to the consumer 120. Again, in certain examples, the invoice may be nothing more than a web page within a virtual shopping cart or similar web page that can facilitate processing online (electronic) transactions.

At 434, the method 400 continues with the consumer 120 receiving the invoice generated by the merchant 110. At 436, the method 400 can continue with the consumer 120 sending the invoice received from the merchant 110 to the coupon redeemer 140 along with the coupon reference. In an example using a virtual shopping cart, the consumer 120 can enter an identifier associated with the coupon reference into the virtual shopping cart checkout page to request validation of the coupon (and send the information to the coupon redeemer 140).

At 450, the method 400 continues with the coupon redeemer 140 receiving the invoice (also referred to as a payment request) and coupon reference from the consumer 120. At 452, the method 400 continues with the coupon redeemer 140 sending the coupon reference to the coupon creator 130 in order to access the digital coupon. In another example, the coupon redeemer 140 can use the coupon reference to directly access a digital coupon repository (e.g., database) to access the digital coupon.

At 426, the method 400 continues with coupon creator 130 receiving the coupon reference, retrieving the digital coupon and sending the digital coupon back to the coupon redeemer 140 for validation and application against the pending transaction. At 454, the method 400 continues with the coupon redeemer 140 receiving the digital coupon from the coupon creator 130. At 456, the method 400 continues with the coupon redeemer 140 validating the digital coupon using the associated parameters and the invoice. For example, the coupon redeemer 140 can check to see that the current date is within the valid dates of use defined for the digital coupon by the merchant 110. The coupon redeemer 140 may also validate that the items included within the invoice satisfy any rules related to coupon application associated with the digital coupon (e.g., not valid for purchase of MP3 players).

At 458, the method 400 continues with the coupon redeemer 140 updating the invoice to reflect application of the digital coupon against the pending transaction. At 460, the method 400 continues with the coupon redeemer 140 sending the updated invoice back to the consumer 120 for approval. In some examples, consumer approval of digital coupon application may be skipped. In certain examples, the consumer 120 may only be notified if the digital coupon cannot be validated against the pending transaction.

At 438, the method 400 continues with the consumer 120 receiving the updated invoice for approval. At 440, the method 400 continues with the consumer 120 approving the updated invoice for payment and sending notification of such to the coupon redeemer 140 (in the examples where the coupon redeemer 140 is responsible for payment processing). At 462, the method 400 continues with the coupon redeemer 140 receiving approval of the updated invoice from the consumer 120 and processing payment based on the updated invoice. The method 400 can conclude at 464 with the coupon redeemer 140 notifying the merchant regarding the digital coupon redemption.

In an example, validating the digital coupon at operation 456 can include decrypting an encrypted digital coupon. In certain examples, the coupon redeemer 140 can use a public key received from the coupon creator 130 to decrypt the digital coupon.

### Example Digital Coupon Platform

FIG. 5 is a block diagram illustrating an example architecture for a network-based publication system within which methods and systems for digital coupon creation and redemption can be implemented. The block diagram depicting a client-server system 500, within which an example embodiment can be deployed. A networked system 502, in the example forms of a network-based marketplace, on-line retail site, or publication system, provides server-side functionality, via a network 504 (e.g., the Internet or Wide Area Network (WAN)) to one or more clients 510, 512. FIG. 5 illustrates, for example, a web client 506 (e.g., a browser, such as the INTERNET EXPLORER browser developed by Microsoft Corporation of Redmond, Wash. State), and a programmatic client 508 executing on respective client machines 510 and 512. In an example, the networked system 502 can perform the functions of both the coupon creator 130 and the coupon redeemer 140 discussed in FIGS. 1-4. In some examples, the networked system 502 performs only the functions associated with the coupon creator 130, while the functions associated with the coupon redeemer 140 are performed by an external payment processing service. In yet other examples, the networked system 502 enables the use of coupons, but does not perform functions associated with either the coupon creator 130 or the coupon redeemer 140.

An Application Program Interface (API) server 514 and a web server 516 are coupled to, and provide programmatic and web interfaces respectively to, one or more application servers 518. The application servers 518 host one or more publication applications 520, payment applications 522, and coupon applications 532. The application servers 518 are, in turn, shown to be coupled to one or more databases servers 524 that facilitate access to one or more databases 526. In some examples, the application server 518 can access the databases 526 directly without the need for a database server 524.

The publication applications 520 may provide a number of publication functions and services to users that access the networked system 502. The payment applications 522 may likewise provide a number of payment services and functions to users. The payment applications 522 may allow users to accumulate value (e.g., in a commercial currency, such as the U.S. dollar, or a proprietary currency, such as “points”) in accounts, and then later to redeem the accumulated value for products (e.g., goods or services) that are made available via the publication system applications 520. The payment application 522 may also be configured to allow for the redemption of coupons issued by the coupon applications 532 (e.g., perform the functions described above in reference to the coupon redeemer 140). The coupon applications 532 may provide a number of coupon related services and functions to users and merchants (e.g., perform the functions described above in reference to the coupon creator 130). The coupon applications 532 may be configured to issue coupons directly to users of the networked system 502. Additionally, the coupon applications 532 are configurable to send coupons to users via communication channels external to the networked system 502, such as email or standard postal mail. The coupon applications 532 may also be responsible for surfacing coupons within the networked system 502 during a user session. Surfacing (or presenting) coupons to a user can be done in a manner that is contextually relevant to the portion of the networked system 502 currently being interacted with by the user. While the publication, payment, and coupon applications 520, 522 and 532 are shown in FIG. 5 to all form part of the networked system 502, it will be appreciated that, in alternative embodiments, the payment applications 522 may form part of a payment service that is separate and distinct from the networked system 502. In an example, the networked system 502 performs the function of the coupon creator 130 and the coupon redeemer 140 functions are performed by an external payment service (processor). For example, a payment service that could provide services described herein can include the PayPal™ payment service (from eBay, Inc. of San Jose, Calif.).

Further, while the system 500 shown in FIG. 5 employs a client-server architecture, the present subject matter is, of course, not limited to such an architecture and could equally well find application in a distributed, or peer-to-peer, architecture system, for example. The various publication, payment, and coupon applications 520, 522 and 532 could also be implemented as standalone software programs, which do not necessarily have networking capabilities.

The web client 506 accesses the various publication, payment, and coupon applications 520, 522 and 532 via the web interface supported by the web server 516. Similarly, the programmatic client 508 accesses the various services and functions provided by the publication, payment, and coupon applications 520, 522 and 532 via the programmatic interface provided by the API server 514. The programmatic client 508 may, for example, be a seller application (e.g., the TURBOLISTER application developed by eBay Inc., of San Jose, Calif.) to enable sellers to author and manage listings on the networked system 502 in an off-line manner, and to perform batch-mode communications between the programmatic client 508 and the networked system 502. Programmatic clients 508 can also be provided that enable sellers to author and manage coupons and coupon campaigns on the networked system 502 in either an online or off-line mode.

FIG. 5 also illustrates a third party application 528, executing on a third party server machine 530, as having programmatic access to the networked system 502 via the programmatic interface provided by the API server 514. For example, the third party application 528 may, utilizing information retrieved from the networked system 502, support one or more features or functions on a website hosted by the third party. The third party website may, for example, provide one or more promotional, publication or payment functions that are supported by the relevant applications of the networked system 502. Additionally, the third party website may provide a user access to view coupons issued by the networked system 502 through the coupon applications 532.

### Example Coupon Modules

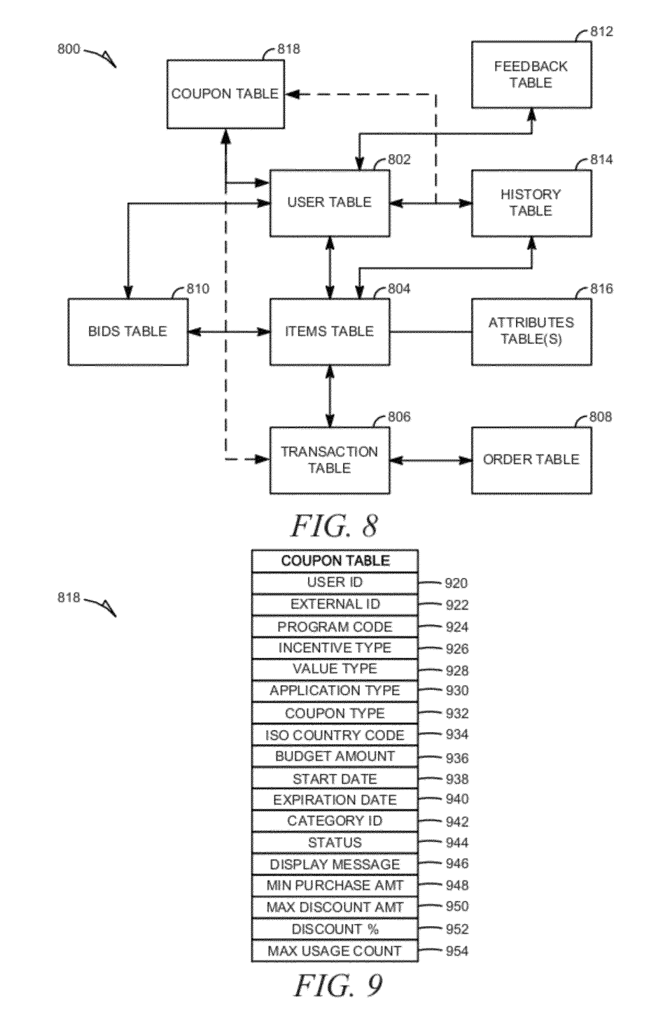

FIG. 6 is a block diagram illustrating an example couponing system 600 for dynamically issuing (creating) coupons. As shown in the example illustrated by FIG. 6, the system 600 includes coupon modules 614, a checkout module 616 and the databases 526. The coupon modules 614 include a targeting module 602, a coupon infrastructure 604, and a coupon widget 606. In certain examples, the coupon infrastructure 604 includes a coupon rules engine 608, a coupon generation engine 610, and a coupon database 612. The coupon database 612 can be a separate stand-alone database within the coupon infrastructure 604 or it can be one or more interconnected tables within the databases 526, such as the coupon table 818 illustrated in FIGS. 8 and 9. In an example, the coupon modules 614 can perform the functions described above in reference to the coupon creator 130, as well as the functions described below.

The targeting module 602 is configurable to create coupon issuance models used by the coupon infrastructure 604 to generate coupons for users of the networked system 502. The targeting module 602 is configurable to create lists of users who are eligible to be issued coupons. In an example, the targeting module 602 receives instructions from one or more of the publication system applications 520 to pull data from the databases 526 to create lists of coupon eligible users. In certain examples, the targeting module 602 stores various coupon issuance models within the databases 526 for use in future couponing campaigns. The coupon issuance models can include various conditions that are evaluated by the coupon infrastructure 604 in determining whether to issue a coupon. In certain examples, the targeting module can deliver coupons through various messaging applications based on a list of eligible users.

The coupon infrastructure 604, in some example embodiments, is responsible for evaluating coupon issuance models as well as generating and storing coupons for use by users within the networked system 502. In an example, the coupon infrastructure 604 includes a coupon rules engine 608 that can be used to evaluate one or more coupon issuance models. In certain examples, the coupon rules engine 608 also determines whether a targeted user is on a list of users eligible to receive a coupon, before signaling the coupon generation engine 610 to create a coupon. In another example, the coupon rules engine 608 can select contextually relevant coupons for presentation to the user. In this example, the coupon rules engine 608 uses information received regarding a user's current location, environment, and/or context within the networked system 502 to determine which coupons may be relevant for display. In certain examples, the coupon generation engine 610 can generate a coupon represented by coupon metadata, shown below in Table 1 as example XML tags. In other examples, the coupon generation engine 610 generates coupons through interaction with the coupon database 612. The coupon database 612, in some example embodiments, stores all generated coupons for use within the networked system 502. The coupon infrastructure, in certain example embodiments, is configured to transmit coupons through communication channels external to the networked system 502. In some examples, the coupon infrastructure uses various messaging applications (e.g., email, instant messaging, etc.) to handle the communication of coupons.

TABLE 1
Example Coupon Metadata

<CouponMetadata>

<summary_action>insert</summary_action>
<external_id>123456</external_id>
<program_code>CRTYS200</program_code>
<adjacency_id>0</adjacency_id>
<incentive_type>3</incentive_type>
<coupon_value_type>1</coupon_value_type>
<coupon_application_type>1</coupon_application_type>
<coupon_type>1</coupon_type>
<iso_country_code>US</iso_country_code>
<language>EN</language>
<iso_currency_code>USD</iso_currency_code>
<budget_amount>300000</budget_amount>
<start_date>02/01/2008 14:59:59</start_date>
<expiration_date>05/23/2008 00:59:59</expiration_date>
<category_id>14339, 12314, 92382</category_id>

<status>1</status>

<display_message> <![CDATA[This is a custom description. The offer
is {offer}%, up to ${max}. Min purchase is ${min}.]]>
</display_message >
<min_purchase_amount>200</min_purchase_amount>
<coupon_max_discount_amount>500</coupon_max_discount_amount>
<faq_url>http://www.mpname.com/us_termsfaq.html</faq_url>
<coupon_discount_percent>14.5</coupon_discount_percent>
<incntv_max_usage_count>5</incntv_max_usage_count>

</CouponMetadata>

The coupon widget 606 is configurable to present coupons generated by the coupon infrastructure 604 to a user accessing the networked system 502. In certain examples, the coupon widget can also be configured to communicate coupons over various communication channels, both internal and external to the networked system 502, by leveraging messaging applications. In some examples, the coupon widget 606 may be a small applet that runs within a third party application 528 to display coupons to registered users of the networked system 502. For example, a Facebook application can incorporate the coupon widget 606 and be configured to display coupons to a user within the user's Facebook account. In these examples, the coupon widget 606 is configurable to communication through the API server 514 in order to access the coupon infrastructure 604. In these various examples, the coupon infrastructure 604 can coordinate delivery of a targeted coupon to a user through the coupon widget 606 and various messaging applications internal or external to the networked system 502. The coupon widget 606 can also present contextually relevant coupons selected by the coupon rules engine 608 based on current user interactions with the networked system 502.

The checkout module 616 is configurable to allow a user of the networked system 502 to complete the purchase process. The coupon widget 606 is configurable to work in conjunction with the checkout module 616 to present contextually relevant coupons to the user during the checkout process. In some examples, the coupon widget 606 can display only those coupons that can be applied to the items the user is attempting to checkout using the checkout module 616. In certain examples, the checkout module 616 can support selection of coupons stored in the coupon infrastructure 604 as well as entry of digital coupon references discussed above.

### Example Coupon Creation System

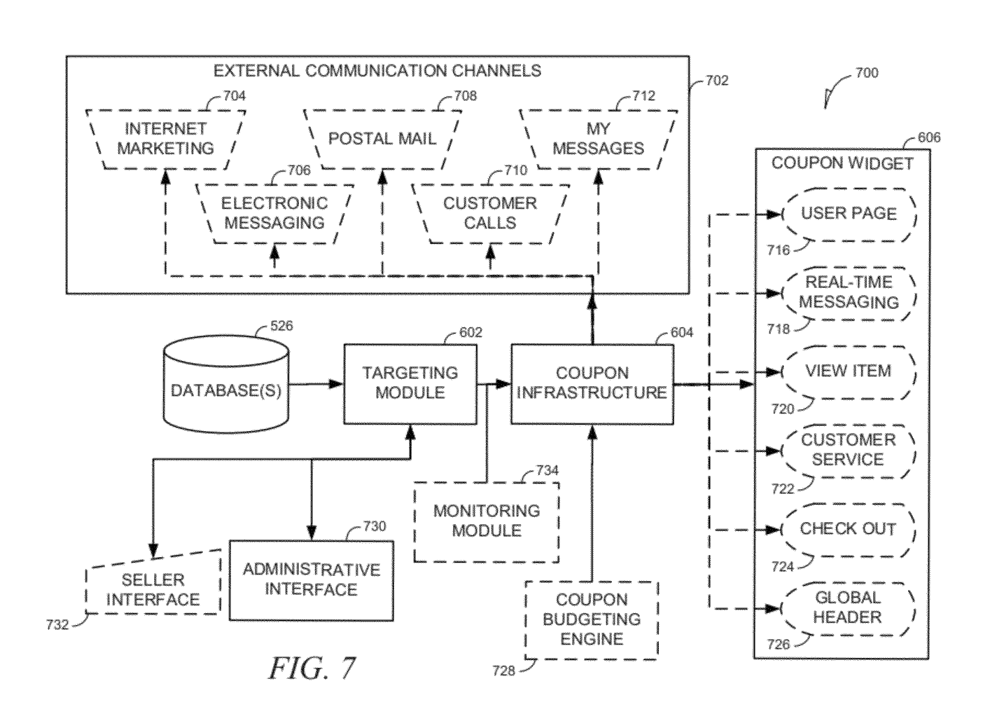

FIG. 7 is a block diagram illustrating an example coupon system 700, which can be implemented as part of a networked system 502. In an example embodiment, the coupon system 700 includes the targeting module 602, the coupon infrastructure 604, the coupon widget 606, external communication channels 702, an administrative interface 730, and the databases 526. In some examples, the coupon system 700 also includes a seller (merchant) interface 732, a monitoring module 734, and a coupon budgeting engine 728.

The coupon system 700, in an example embodiment, includes various external communication channels, such as internet marketing 704, electronic messaging 706, postal mail 708, customer calls 710 and my messages 712. In an example, the internet marketing channel 704 can be used to present targeted user coupons to registered users of the networked system 502 while the user is accessing a third party's web site or application. For example, the internet marketing channel 704 is configurable to deliver targeted coupons through Internet search engines, such as www.yahoo.com (provided by Yahoo!, Inc. of Sunnyvale, Calif.). In some examples, the external communication channels 702 can also be supported through various messaging applications. For example, the “my messages” channel 712 can be an external messaging system operating on the networked system 502 and supported by an instant messaging application.

In various example embodiments, the coupon widget 606 is configurable to surface coupons within the networked system 502 through a user page 716, real-time messaging 718, a view item listing page 720, a customer service interface 722, a checkout mechanism 724, and a global web page header 726. The user page 716 can be provided through various personalization applications and is configurable to display information associated with a registered user's interactions with the networked system 502. In an example, real-time messaging 718 is configurable to display messages, such as coupons, to a user browsing on the networked system 502. For example, a user may enter a search request on the networked system 502, the search request can return a list of results, and a portion of the web page may include a message delivered through real-time messaging 718. The message delivered through real-time messaging 718 can include one or more coupons issued to the user relevant to the search results. In certain examples, each web page generated by the networked system 502 can include a common global web page header 726 with a section dedicated to displaying information associated with a registered user. In an example embodiment, the coupon infrastructure 604 coordinates coupon delivery between the external communication channels 702 and the coupon widget 606. For example, a coupon generated for a specific user can be delivered to the networked system 502 via the coupon widget 606, while the same coupon is sent via electronic messaging 706 to the user's cellular phone. In this example, within the networked system 502, the coupon widget 606 may surface the coupon within the user's user page 716 or through the global web page header 726.

In an example, the administrative interface 730 can be used to setup coupon campaigns within the targeting module 602. Coupon campaigns can include the creation of a list of users eligible to receive a coupon as well as one or more rules or conditions, which may be stored in a coupon issuance model. In certain examples, the administrative interface 730 can be used to create and store, within the database 526, coupon issuance models for future coupon campaigns. In these examples, a coupon campaign refers to the creation of a promotion within the networked system 502 to encourage users to make purchases through issuing coupons, such as five (5) dollars off your next purchase or ten percent (10%) off an iPod brand music player (from Apple, Inc. of Cupertino, Calif.). In some examples, the coupon budgeting engine 728 can be used to configure the financial aspects of a coupon campaign, as well as the start and end dates of the campaign. For example, through the coupon budgeting engine 728, a seller or merchandiser can configure a coupon campaign to issue up to $5000 in a certain type of coupon and have the campaign run from May 1st through September 1st. In another example, the coupon budgeting engine 728 can monitor the coupon infrastructure 604 to determine when a pre-selected dollar amount of issued coupons have been redeemed as a measure of when to end a coupon campaign.

In some example embodiments, the monitoring module 734 is configurable to track the activity of a user interacting with the networked system 502. The monitoring module 734 can provide this real-time activity information to the coupon infrastructure 604 for use in evaluating whether a user has met the necessary conditions to issue a coupon. For example, a certain coupon campaign may require that a user view three listings within a certain category during a single user session prior to issuing a coupon. In this example, the monitoring module 734 can track the user's interactions and provide real-time information to the coupon rules engine 608 so that the condition can be evaluated. As soon as the user visits the third listing within a specified category, the coupon rules engine 608 can trigger the coupon generation engine 610 issue a coupon to the user, which can then be presented through the coupon widget 606. In this example, the coupon widget 606 can present the coupon during the current user session, while the user may still be considering a purchase. The monitoring module 734 can also provide information to the coupon infrastructure to enable contextual display of coupons based on a user's current location within the networked system 502.

### Data Structures

FIG. 8 is a high-level entity-relationship diagram, illustrating various tables 800 that may be maintained within the databases 526, and that are utilized by and support the applications 520, 522, and 532. A user table 802 contains a record for each registered user of the networked system 502, and may include identifier, address and financial instrument information pertaining to each such registered user. A user may operate as a seller, a buyer, or both, within the networked system 502. In one example embodiment, a buyer may be a user that has accumulated value (e.g., commercial or proprietary currency), and is accordingly able to exchange the accumulated value for items that are offered for sale by the networked system 502.

The tables 800 can also include an items table 804 in which are maintained item records for goods and services that are available to be, or have been, transacted via the networked system 502. Each item record within the items table 804 may furthermore be linked to one or more user records within the user table 802, so as to associate a seller and one or more actual or potential buyers with each item record.

A transaction table 806 contains a record for each transaction (e.g., a purchase or sale transaction) pertaining to items for which records exist within the items table 804.

An order table 808 is populated with order records, with each order record being associated with an order. Each order, in turn, may be associated with one or more transactions for which records exist within the transaction table 806.

Bid records within a bids table 810 each relate to a bid received at the networked system 502 in connection with an auction-format listing supported by an auction application (not shown). A feedback table 812 is utilized by one or more reputation applications (not shown), in one example embodiment, to construct and maintain reputation information concerning users. A history table 814 maintains a history of transactions to which a user has been a party. One or more attributes tables 816 record attribute information pertaining to items for which records exist within the items table 804. Considering only a single example of such an attribute, the attributes tables 816 may indicate a currency attribute associated with a particular item, with the currency attribute identifying the currency of a price for the relevant item as specified by a seller.

A coupon table 818 can be populated with coupon records, with each coupon record being associated with a user. In this example, coupons are issued to an individual user. Each coupon may also be associated with a transaction in the transaction table 806, provided that the coupon has been redeemed by the user. A redeemed coupon may also have an associated record in the history table 814.

FIG. 9 is a block diagram illustrating example fields in an example coupon table 818. In an example, the coupon table 818 can include fields including User ID 920, External ID 922, Program Code 924, Incentive Type 926, Value Type 928, Application Type 930, Coupon Type 932, ISO Country Code 934, Budget Amount 936, Start Date 938, Expiration Date 940, Category ID 942, Status 944, Display Message 946, Minimum Purchase Amount 948, Maximum Discount Amount 950, Discount Percentage 952, and Maximum Usage Count 954. In other examples, the coupon table 818 could include additional fields, such as Transaction ID, linking the coupon to a completed transaction. The User ID 920 can be a link into the User Table 802. The External ID 922 can used to identify the coupon in third party systems, for example. In an example, the External ID 922 is the coupon reference used by the consumer 120 to apply the coupon to a purchase transaction. The Program Code 924 can be used to identify the coupon campaign responsible for issuing the coupon. The Incentive Type 926 can be used in an example to indicate who issued the coupon. In some examples, coupons can be issued by the networked system 502, by individual sellers providing merchandise or services through the networked system 502, or by product manufacturers. The Coupon Type 932 can be used to indicate whether the coupon is a fixed value coupon or a percent off coupon. The ISO Country Code 934 can be used to indicate within which countries the coupon is valid. The Budget Amount 936 can be used to indicate the total budget for the coupon campaign. In certain examples, a coupon is configurable to automatically expire once the budget amount assigned to the coupon campaign is reached. The Start Date 938 can be used to indicate the earliest date on which the coupon can be redeemed. The Expiration Date 940 can be used to indicate the last date on which the coupon can be redeemed. In certain examples, a coupon can be associated with a particular product or service category within the networked system 502. In these examples, the Category ID 942 can be used to link the coupon to the valid category. The Status 944 can be used to indicate whether the coupon is active, redeemed, or expired, for example. The Display Message 946 can be used to provide a message to the user upon receiving or redeeming the coupon. The Minimum Purchase Amount 948 can be used to indicate a minimum purchase necessary to redeem the coupon. The Maximum Discount Amount 950 can be used to indicate the maximum dollar value (monetary value) of the coupon. For example, the coupon could be a 10% off coupon with a maximum discount amount of $50, which means that anything purchased over $500 would still only receive $50 off the purchase price. The Discount Percentage 952 can be used to indicate the percent value of a percentage off type coupon. The Maximum Usage Count 954 can be used to indicate how many times a coupon can be redeemed. For example, a single use coupon can have a maximum usage count 954 of one.

The previous paragraph provides a description of an example embodiment of the coupon table 818. The described embodiment can include additional or fewer fields depending upon the capabilities provided within a particular networked system 502. In an example, portions of the coupon table 818 may be encrypted or omitted from the digital coupon provided to the coupon redeemer 140.

### Modules, Components and Logic

Certain embodiments are described herein as including logic or a number of components, modules, or mechanisms. Modules may constitute either software modules (e.g., code embodied on a machine-readable medium or in a transmission signal) or hardware modules. A hardware module is tangible unit capable of performing certain operations and may be configured or arranged in a certain manner. In example embodiments, one or more computer systems (e.g., a standalone, client or server computer system) or one or more hardware modules of a computer system (e.g., a processor or a group of processors) may be configured by software (e.g., an application or application portion) as a hardware module that operates to perform certain operations as described herein.

In various embodiments, a hardware module may be implemented mechanically or electronically. For example, a hardware module may comprise dedicated circuitry or logic that is permanently configured (e.g., as a special-purpose processor, such as a field programmable gate array (FPGA) or an application-specific integrated circuit (ASIC)) to perform certain operations. A hardware module may also comprise programmable logic or circuitry (e.g., as encompassed within a general-purpose processor or other programmable processor) that is temporarily configured by software to perform certain operations. It will be appreciated that the decision to implement a hardware module mechanically, in dedicated and permanently configured circuitry, or in temporarily configured circuitry (e.g., configured by software) may be driven by cost and time considerations.

Accordingly, the term “hardware module” should be understood to encompass a tangible entity, be that an entity that is physically constructed, permanently configured (e.g., hardwired) or temporarily configured (e.g., programmed) to operate in a certain manner and/or to perform certain operations described herein. Considering embodiments in which hardware modules are temporarily configured (e.g., programmed), each of the hardware modules need not be configured or instantiated at any one instance in time. For example, where the hardware modules comprise a general-purpose processor configured using software, the general-purpose processor may be configured as respective different hardware modules at different times. Software may accordingly configure a processor, for example, to constitute a particular hardware module at one instance of time and to constitute a different hardware module at a different instance of time.

Hardware modules can provide information to, and receive information from, other hardware modules. Accordingly, the described hardware modules may be regarded as being communicatively coupled. Where multiple such hardware modules exist contemporaneously, communications may be achieved through signal transmission (e.g., over appropriate circuits and buses) that connect the hardware modules. In embodiments in which multiple hardware modules are configured or instantiated at different times, communications between such hardware modules may be achieved, for example, through the storage and retrieval of information in memory structures to which the multiple hardware modules have access. For example, one hardware module may perform an operation and store the output of that operation in a memory device to which it is communicatively coupled. A further hardware module may then, at a later time, access the memory device to retrieve and process the stored output. Hardware modules may also initiate communications with input or output devices, and can operate on a resource (e.g., a collection of information).

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions. The modules referred to herein may, in some example embodiments, comprise processor-implemented modules.

Similarly, the methods described herein may be at least partially processor-implemented. For example, at least some of the operations of a method may be performed by one or processors or processor-implemented modules. The performance of certain of the operations may be distributed among the one or more processors, not only residing within a single machine, but deployed across a number of machines. In some example embodiments, the processor or processors may be located in a single location (e.g., within a home environment, an office environment or as a server farm), while in other embodiments the processors may be distributed across a number of locations.

The one or more processors may also operate to support performance of the relevant operations in a “cloud computing” environment or as a “software as a service” (SaaS). For example, at least some of the operations may be performed by a group of computers (as examples of machines including processors), these operations being accessible via a network (e.g., the Internet) and via one or more appropriate interfaces (e.g., APIs).

### Electronic Apparatus and System

Example embodiments may be implemented in digital electronic circuitry, or in computer hardware, firmware, software, or in combinations of them. Example embodiments may be implemented using a computer program product, e.g., a computer program tangibly embodied in an information carrier, e.g., in a machine-readable medium for execution by, or to control the operation of, data processing apparatus, e.g., a programmable processor, a computer, or multiple computers.

A computer program can be written in any form of programming language, including compiled or interpreted languages, and it can be deployed in any form, including as a stand-alone program or as a module, subroutine, or other unit suitable for use in a computing environment. A computer program can be deployed to be executed on one computer or on multiple computers at one site or distributed across multiple sites and interconnected by a communications network.

In example embodiments, operations may be performed by one or more programmable processors executing a computer program to perform functions by operating on input data and generating output. Method operations can also be performed by, and apparatus of example embodiments may be implemented as, special purpose logic circuitry (e.g., a field programmable gate array (FPGA) or an application-specific integrated circuit (ASIC)).

The computing system can include clients and servers. A client and server are generally remote from each other and typically interact through a communication network. The relationship of client and server arises by virtue of computer programs running on the respective computers and having a client-server relationship to each other. In embodiments deploying a programmable computing system, it will be appreciated that both hardware and software architectures require consideration. Specifically, it will be appreciated that the choice of whether to implement certain functionality in permanently configured hardware (e.g., an ASIC), in temporarily configured hardware (e.g., a combination of software and a programmable processor), or a combination of permanently and temporarily configured hardware may be a design choice. Below are set out hardware (e.g., machine) and software architectures that may be deployed, in various example embodiments.

### Example Machine Architecture and Machine-Readable Medium

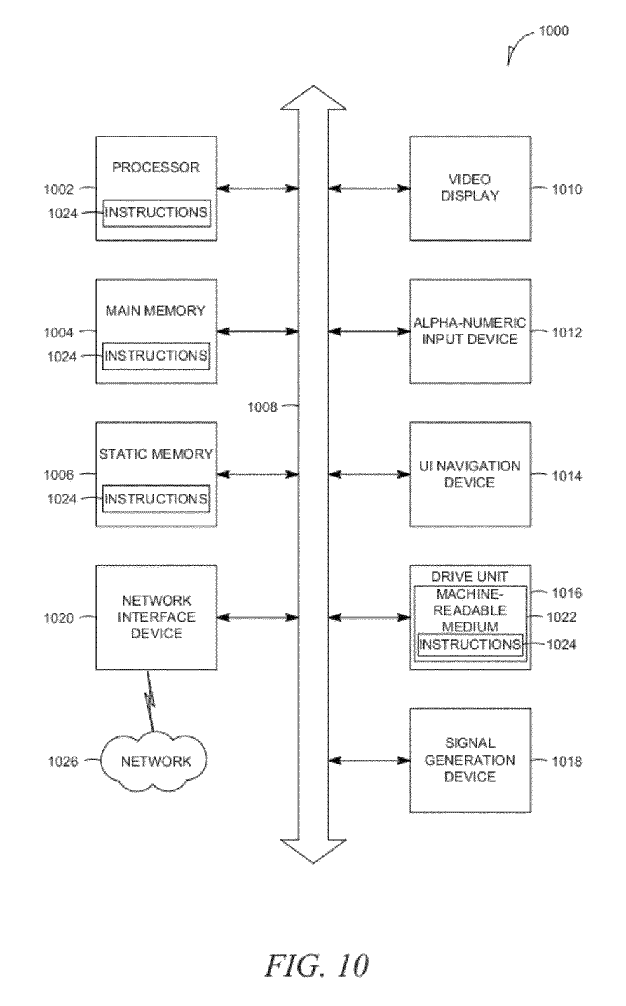

FIG. 10 is a block diagram of machine in the example form of a computer system 1000 within which instructions, for causing the machine to perform any one or more of the methodologies discussed herein, may be executed. In alternative embodiments, the machine operates as a standalone device or may be connected (e.g., networked) to other machines. In a networked deployment, the machine may operate in the capacity of a server or a client machine in server-client network environment, or as a peer machine in a peer-to-peer (or distributed) network environment. The machine may be a personal computer (PC), a tablet PC, a set-top box (STB), a Personal Digital Assistant (PDA), a cellular telephone, a web appliance, a network router, switch or bridge, or any machine capable of executing instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The example computer system 1000 includes a processor 1002 (e.g., a central processing unit (CPU), a graphics processing unit (GPU) or both), a main memory 1004 and a static memory 1006, which communicate with each other via a bus 1008. The computer system 1000 may further include a video display unit 1010 (e.g., a liquid crystal display (LCD) or a cathode ray tube (CRT)). The computer system 1000 also includes an alphanumeric input device 1012 (e.g., a keyboard), a user interface (UI) navigation device 1014 (e.g., a mouse), a disk drive unit 1016, a signal generation device 1018 (e.g., a speaker) and a network interface device 1020.

### Machine-Readable Medium

The disk drive unit 1016 includes a machine-readable medium 1022 on which is stored one or more sets of instructions and data structures (e.g., software) 1024 embodying or utilized by any one or more of the methodologies or functions described herein. The instructions 1024 may also reside, completely or at least partially, within the main memory 1004 and/or within the processor 1002 during execution thereof by the computer system 1000, the main memory 1004 and the processor 1002 also constituting machine-readable media.

While the machine-readable medium 1022 is shown in an example embodiment to be a single medium, the term “machine-readable medium” may include a single medium or multiple media (e.g., a centralized or distributed database, and/or associated caches and servers) that store the one or more instructions or data structures. The term “machine-readable medium” shall also be taken to include any tangible medium that is capable of storing, encoding or carrying instructions for execution by the machine and that cause the machine to perform any one or more of the methodologies of the present subject matter, or that is capable of storing, encoding or carrying data structures utilized by or associated with such instructions. The term “machine-readable medium” shall accordingly be taken to include, but not be limited to, solid-state memories, and optical and magnetic media. Specific examples of machine-readable media include non-volatile memory, including by way of example, semiconductor memory devices, e.g., Erasable Programmable Read-Only Memory (EPROM), Electrically Erasable Programmable Read-Only Memory (EEPROM), and flash memory devices; magnetic disks such as internal hard disks and removable disks; magneto-optical disks; and CD-ROM and DVD-ROM disks.

### Transmission Medium

The instructions 1024 may further be transmitted or received over a communications network 1026 using a transmission medium. The instructions 1024 may be transmitted using the network interface device 1020 and any one of a number of well-known transfer protocols (e.g., HTTP). Examples of communication networks include a local area network (LAN), a WAN, the Internet, mobile telephone networks, Plain Old Telephone (POTS) networks, and wireless data networks (e.g., WiFi and WiMax networks). The term “transmission medium” shall be taken to include any intangible medium that is capable of storing, encoding or carrying instructions for execution by the machine, and includes digital or analog communications signals or other intangible media to facilitate communication of such software.

Thus, a method and system to dynamically issue coupons to a user on a network-based publication system have been described. Although the present subject matter has been described with reference to specific example embodiments, it will be evident that various modifications and changes may be made to these embodiments without departing from the broader spirit and scope of the subject matter. Accordingly, the specification and drawings are to be regarded in an illustrative rather than a restrictive sense.

Although an embodiment has been described with reference to specific example embodiments, it will be evident that various modifications and changes may be made to these embodiments without departing from the broader spirit and scope of the subject matter. Accordingly, the specification and drawings are to be regarded in an illustrative rather than a restrictive sense. The accompanying drawings that form a part hereof, show by way of illustration, and not of limitation, specific embodiments in which the subject matter may be practiced. The embodiments illustrated are described in sufficient detail to enable those skilled in the art to practice the teachings disclosed herein. Other embodiments may be utilized and derived therefrom, such that structural and logical substitutions and changes may be made without departing from the scope of this disclosure. This Detailed Description, therefore, is not to be taken in a limiting sense, and the scope of various embodiments is defined only by the appended claims, along with the full range of equivalents to which such claims are entitled.

Such embodiments of the inventive subject matter may be referred to herein, individually and/or collectively, by the term “invention” merely for convenience and without intending to voluntarily limit the scope of this application to any single invention or inventive concept if more than one is in fact disclosed. Thus, although specific embodiments have been illustrated and described herein, it should be appreciated that any arrangement calculated to achieve the same purpose may be substituted for the specific embodiments shown. This disclosure is intended to cover any and all adaptations or variations of various embodiments. Combinations of the above embodiments, and other embodiments not specifically described herein, will be apparent to those of skill in the art upon reviewing the above description.

All publications, patents, and patent documents referred to in this document are incorporated by reference herein in their entirety, as though individually incorporated by reference. In the event of inconsistent usages between this document and those documents so incorporated by reference, the usage in the incorporated reference(s) should be considered supplementary to that of this document; for irreconcilable inconsistencies, the usage in this document controls.

In this document, the terms “a” or “an” are used, as is common in patent documents, to include one or more than one, independent of any other instances or usages of “at least one” or “one or more.” In this document, the term “or” is used to refer to a nonexclusive or, such that “A or B” includes “A but not B,” “B but not A,” and “A and B,” unless otherwise indicated. In the appended claims, the terms “including” and “in which” are used as the plain-English equivalents of the respective terms “comprising” and “wherein.” Also, in the following claims, the terms “including” and “comprising” are open-ended, that is, a system, device, article, or process that includes elements in addition to those listed after such a term in a claim are still deemed to fall within the scope of that claim. Moreover, in the following claims, the terms “first,” “second,” “third,” and so forth are used merely as labels and are not intended to impose numerical requirements on their objects.

The Abstract of the Disclosure is provided to comply with 37 C.F.R. §1.72(b), requiring an abstract that will allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in a single embodiment for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separate embodiment.

1. A method comprising:
receiving, over a network connection at a payment processor, a payment request from a user, the payment request including transaction data, received from a merchant by the user, allowing the payment processor to transfer funds between the user and a merchant and also including a reference to a digital coupon associated with an item included in the payment request, the reference identifying the digital coupon maintained by a coupon issuer;
accessing, at the payment processor, the digital coupon using the reference received from the user within the payment request, the accessing including receiving, over the network connection, the digital coupon from the coupon issuer;
validating the digital coupon on the payment processor using a payment transaction system including one or more computer processing units (CPUs) in order to create a validated digital coupon;
applying, at the payment processor using the payment transaction system, the validated digital coupon against the payment request to create a revised payment request; and
processing, at the payment processor using the payment transaction system, payment of the revised payment request.

2. The method of claim 1, wherein the applying the validated digital coupon includes obtaining approval from the user regarding the revised payment request.

3. The method of claim 2, wherein the obtaining approval from the user includes sending the user the revised payment request.

4. The method of claim 3, wherein the sending the user the revised payment request includes sending a revised invoice, wherein the revised invoice includes an item referenced by the digital coupon.

5. The method of claim 1, wherein the receiving the payment request includes receiving an invoice generated by the merchant.

6. The method of claim 1, wherein the receiving the payment request includes receiving a user ID associated with the user and a merchant ID associated with the merchant, the user ID and merchant ID being sufficient information for the payment processor to transfer funds between the user and the merchant.

7. The method of claim 1, wherein the validating the digital coupon includes decrypting the digital coupon.

8. The method of claim 1, wherein the validating the digital coupon includes receiving confirmation of the digital coupon from the merchant.

9. The method of claim 8, wherein the receiving confirmation of an aspect of the digital coupon includes receiving confirmation of one or more of the following aspects of a digital coupon:
value of the digital coupon;
expiration date;
applicable item;
applicable category of items; and
value of items the digital coupon is to be applied to.

10. (canceled)

11. A machine-readable storage medium comprising instructions, which when executed, by one or more processors within a payment transaction processing system, cause the payment transaction processing system to:
receive a payment request from a user, the payment request including transaction data allowing the payment transaction processing system to transfer funds between the user and a merchant and also including a reference to a digital coupon associated with an item included in the payment request, the reference identifying the digital coupon maintained by a coupon issuer;
access the digital coupon using the reference received from the user within the payment request, the digital coupon received, over a network connection, from the coupon issuer;
validate the digital coupon to create a validated digital coupon;
apply the validated digital coupon against the payment request to create a revised payment request; and
process a transfer of funds between the user and the merchant based on the revised payment request.

12. The machine-readable storage medium of claim 11, wherein the instructions which cause the payment transaction processing system to apply the validated digital coupon include instructions which cause the payment transaction processing system to obtain approval from the user regarding the revised payment request.

13. The machine-readable storage medium of claim 12, wherein the instructions which cause the payment transaction processing system to obtain approval from the user include instructions which cause the payment transaction processing system to send the user the revised payment request.

14. The machine-readable storage medium of claim 13, wherein the instructions which cause the payment transaction processing system to send the user the revised payment request include instructions which cause the payment transaction processing system to send a revised invoice, wherein the revised invoice includes an item referenced by the digital coupon.

15. The machine-readable storage medium of claim 11, wherein the instructions which cause the payment transaction processing system to receive the payment request include instructions which cause the payment transaction processing system to receive an invoice generated by the merchant.

16. The machine-readable storage medium of claim 11, wherein the instructions which cause the payment transaction processing system to receive the payment request include instructions which cause the payment transaction processing system to receive a user ID associated with the user and a merchant ID associated with the merchant, the user ID and merchant ID being sufficient information for the payment transaction processing system to transfer funds between the user and the merchant.

17. The machine-readable storage medium of claim 11, wherein the instructions which cause the payment transaction processing system to validate the digital coupon include instructions which cause the payment transaction processing system to decrypt the digital coupon.

18. The method of claim 11, wherein the instructions which cause the payment transaction processing system to validate the digital coupon include instructions which cause the payment transaction processing system to receive confirmation of the coupon from the merchant.

19. The method of claim 18, wherein the instructions which cause the payment transaction processing system to receive confirmation of the digital coupon include instructions which cause the payment transaction processing system to receive confirmation of one or more of the following aspects of a digital coupon:
value of the digital coupon;
expiration date;
applicable item;
applicable category of items; and
value of items the digital coupon is to be applied to.

20. (canceled)

21. The machine-readable storage medium of claim 1, wherein the instructions which cause the payment transaction processing system to receive the digital coupon from the coupon creator include instructions which cause the payment transaction processing system to receive a key, for decrypting the digital coupon, from the coupon creator.

22. A system comprising:
a network;
a payment transaction processing server including a network adaptor coupled to the network and a processor coupled to a tangible machine-readable storage medium, the machine-readable storage medium including instructions, which when executed by the processor cause the payment transaction processing server to:
receive, over the network, a payment request from a user, the payment request including transaction data allowing the payment transaction processing server to transfer funds between the user and a merchant and also including a reference to a digital coupon associated with an item included in the payment request, the reference identifying the digital coupon maintained by a coupon issuer;
access the digital coupon using the reference received from the user within the payment request, the digital coupon received, over the network, from the coupon issuer;
validate the digital coupon to create a validated digital coupon;
apply the validated digital coupon against the payment request to create a revised payment request; and
process a transfer of funds between the user and the merchant based on the revised payment request.
